(19) United States
(12) Patent Application Publication
(10) Pub. No.: US 2026/0142413 A1
(43) Pub. Date: May 21, 2026

(54) CONNECTOR STRUCTURE

(71) Applicants: Yazaki Corporation, Tokyo (JP); DENSO CORPORATION, Kariya-city (JP)

(72) Inventors: Yasuhiro SASAKI, Makinohara-shi (JP); Tomoaki YOSHIMI, Aichi (JP); Naohiro YAMAMOTO, Aichi (JP)

(73) Assignees: Yazaki Corporation, Tokyo (JP); DENSO CORPORATION, Kariya-city (JP)

(21) Appl. No.: 19/447,527

(22) Filed: Jan. 13, 2026

Related U.S. Application Data
(63) Continuation of application No. PCT/JP2024/023095, filed on Jun. 26, 2024.

(30) Foreign Application Priority Data
Jul. 25, 2023 (JP) 2023-120688

(51) Int. Cl. H01R 13/629; H01R 13/627; H01R 13/631; H01R 27/02

(52) U.S. Cl. CPC H01R 13/62938; H01R 13/6272; H01R 13/62955; H01R 13/631; H01R 27/02; H01R 2201/26

(57) ABSTRACT

A connector structure includes: a base; a pair of first connectors standing from the base; and a lever connector mated with the pair of first connectors, wherein each first connector includes: a first housing having a tubular shape and standing from the base; and a pair of bosses protruding from an outer surface of the first housing, wherein the lever connector includes: a lever housing mated with the first housing; and a lever including boss grooves, each boss groove being configured to insert one of the pair of bosses therein, wherein the lever is pivotably supported by the lever housing so that rotation of the lever moves the first housing and the lever housing toward each other, wherein the pair of bosses is facing away from each other in an orthogonal direction extending orthogonally to a direction of arrangement in which the pair of first connectors is arranged.

### CROSS REFERENCE TO RELATED APPLICATIONS

This application is a PCT bypass continuation application of International Application No. PCT/JP 2024/023095, filed on Jun. 26, 2024, which claims priority from Japanese Patent Application No. 2023-120688, filed on Jul. 25, 2023, the contents of all of which are incorporated herein by reference in their entirety.

### BACKGROUND OF THE INVENTION

### Technical Field

The present invention relates to a connector structure.

### Background Art

Conventionally, a drive device is known that is incorporated into an electric power steering system to assist steering operations of a vehicle (see e.g. Patent Document 1). The drive device disclosed in Patent Document 1 includes a motor and a control unit that controls the motor which are integrally assembled.

The control unit includes a pair of boards with one or more electronic devices mounted thereon as well as a connector section, wherein the one or more electronic devices are provided for communication control of a pair of motor windings which form part of the motor.

The connector section includes hybrid connectors and steering system connectors, each of the hybrid connectors including a power connector and a communication connector, wherein the power connectors and communication connectors are connected to a power supply and to a vehicle communication network respectively, and the steering system connector is configured to obtain signals from an internal sensor of an electric power steering system. A pair of hybrid connector and steering system connector is provided for each of the pairs. Moreover, a pair of hybrid connectors is arranged along a right-left direction orthogonal to an axis of each of the windings, a pair of steering system connectors is juxtaposed to the pair of hybrid connectors and arranged along the right-left direction.

### CITATION LIST

### Patent Literature

Patent Document 1: JP 2022-144150 A

### SUMMARY OF THE INVENTION

However, each hybrid connector of the conventional drive device described in Patent Document 1 includes a pair of bosses configured to be engaged with a partner lever-mated connector, wherein the pair of bosses protrudes in the right-left direction (direction of arrangement in which the pair of hybrid connectors is arranged). Therefore, it is difficult to reduce a distance between the pair of hybrid connectors, i.e., to move the pair of hybrid connectors toward each other.

An objective of the present invention is to provide a connector structure 1 which may allow it to be miniaturized in a direction of arrangement in which a pair of first connectors are arranged.

In order to achieve the above-mentioned objective, the invention according to claim 1 relates to a connector structure including: a base; a pair of first connectors standing from the base; and a lever connector configured to be mated with the pair of first connectors, wherein each of the pair of first connectors includes: a first housing having a tubular shape and standing from the base; and a pair of bosses protruding from an outer surface of the first housing, wherein the lever connector includes: a lever housing configured to be mated with the first housing; and a lever including boss grooves, each of the boss grooves being configured to insert one of the pair of bosses therein, wherein the lever is pivotably supported by the lever housing so that rotation of the lever moves the first housing and the lever housing toward each other, wherein the pair of bosses is facing away from each other in an orthogonal direction extending orthogonally to a direction of arrangement in which the pair of first connectors is arranged.

The invention according to claim 1 may achieve miniaturization in a direction of arrangement in which a pair of first connectors.

### BRIEF DESCRIPTION OF THE DRAWINGS

FIG. 1 shows a perspective view of a connector structure according to an embodiment of the present invention, illustrating a mated state of first connectors and lever connectors and a mated state of second connectors and partner connectors;

FIG. 2 shows a perspective view of male connector body forming part of the connector structure;

FIG. 3 shows a side view of the male connector body;

FIG. 4 shows a plan view of the male connector body;

FIG. 5 shows a perspective view of a lever connector, illustrating a state of the lever connector in which it is positioned in an initial position;

FIG. 6 shows a perspective view of the lever connector, illustrating a state of the lever connector in which it is positioned in a completely rotated position;

FIG. 7 shows a perspective view of another example of the lever connector, illustrating a state of the lever connector in which it is positioned in a completely rotated position;

FIG. 8 shows a partial sectional view of the first connector and the lever connector in the mated state; and

FIG. 9 shows a partial sectional view of the second connector and the partner connector in the mated state.

### DETAILED DESCRIPTION OF THE PREFERRED EMBODIMENTS

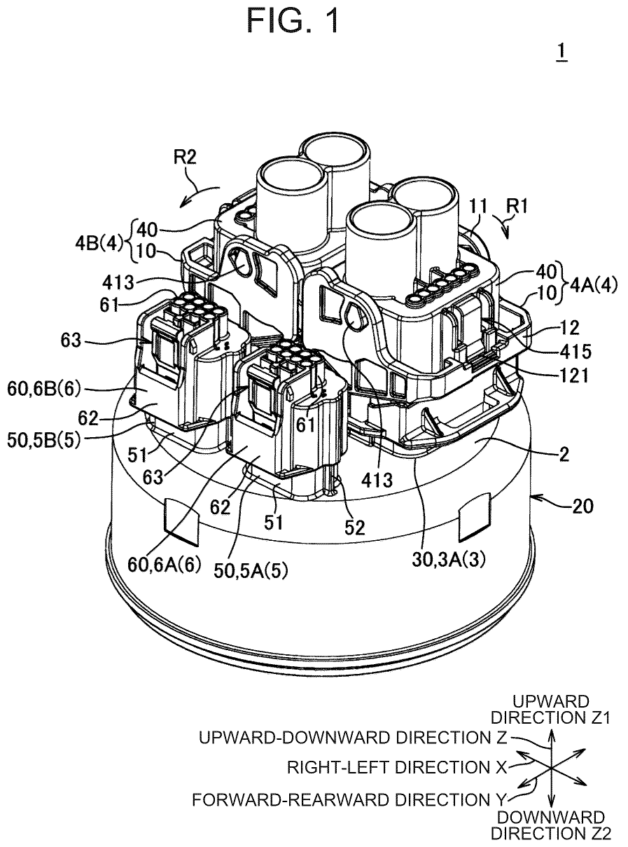

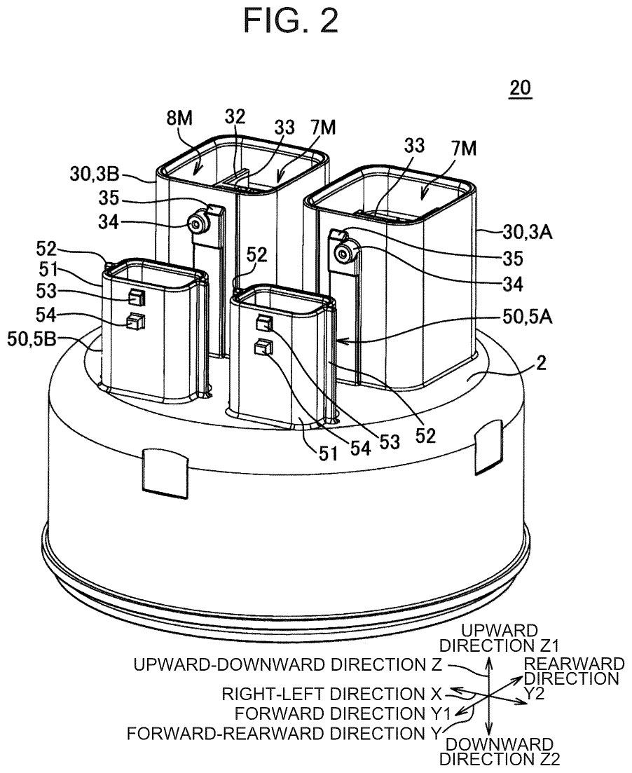

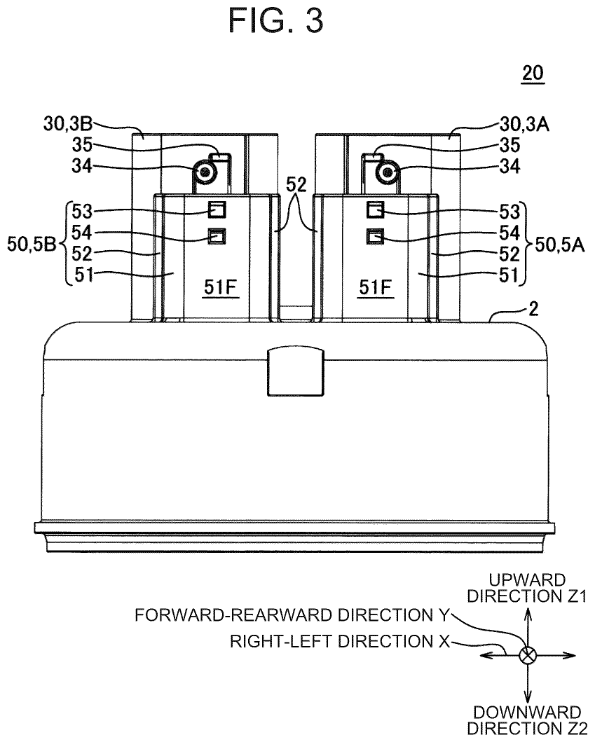

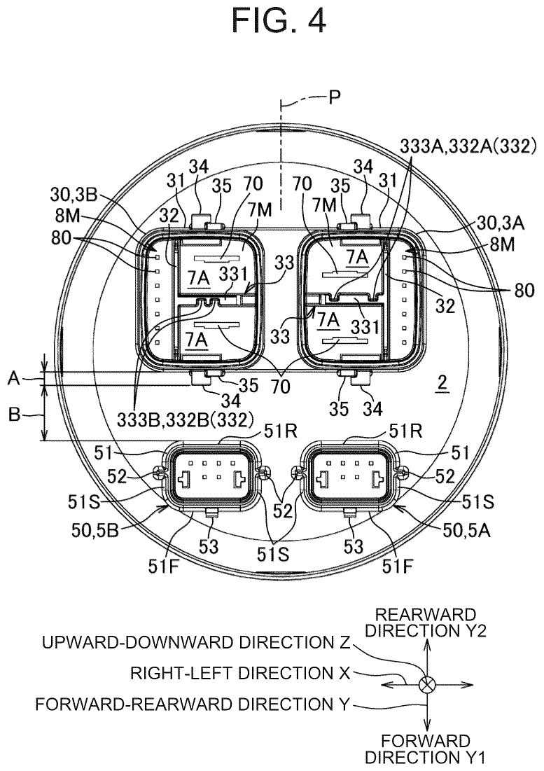

Hereinafter, an embodiment of the present invention will be described with reference to FIGS. 1 to 9. FIG. 1 shows a perspective view of a connector structure 1 according to an embodiment of the present invention, illustrating a mated state of vehicle system male connectors 3 (first connectors) and vehicle system female connectors 4 (lever connectors) and a mated state of steering system male connectors 5 (second connectors) and steering system female connectors 6 (partner connectors). FIG. 2 shows a perspective view of male connector body 20 forming part of the connector structure 1. FIG. 3 shows a side view of the male connector body 20. FIG. 4 shows a plan view of the male connector body 20.

A connector structure 1 according to the present embodiment is integrated into an electric power steering system and forms part of a control unit configured to control a motor. The motor includes a pair of motor windings. Hereinafter, a circuit including one of the pair of motor windings may be referred to as the “first system,” and a circuit including the other of the pair of motor windings may be referred to as the “second system”. The first and second systems are provided for ensuring redundancy and configured with one or more same functions.

As shown in FIG. 1, the connector structure 1 includes a base 2, a pair of vehicle system male connectors 3A and 3B (3) (a pair of first connectors) standing from the base 2, vehicle system female connectors 4A and 4B (4) (lever connectors) configured to be mated with the respective vehicle system male connectors 3A and 3B, a pair of steering system male connectors 5A and 5B (5) (second connectors) standing from the base 2, and steering system female connectors 6A and 6B (6) (partner connectors) configured to be mated with the respective steering system male connectors 5A and 5B, wherein the base 2 is part of a cover of the control unit.

One of the pair of vehicle system male connectors 3A and 3B (hereinafter may be referred to as a first vehicle system male connector 3A (one first connector)) and one of the pair of vehicle system female connectors 4A and 4B (hereinafter may be referred to as a first vehicle system female connector 4A (one lever connector)) are configured to be mated with each other. In a mated state in which the first vehicle system male connector 3A and the first vehicle system female connector 4A are mated with each other, the first vehicle system male connector 3A and the first vehicle system female connector 4A form part of the “first system.”

Another of the pair of vehicle system male connectors 3A and 3B (hereinafter may be referred to as a second vehicle system male connector 3B (another first connector)) and another of the pair of vehicle system female connectors 4A and 4B (hereinafter may be referred to as a second vehicle system female connector 4B (another lever connector)) are configured to be mated with each other. The second vehicle system male connector 3B and the second vehicle system female connector 4B form part of the “second system.”

Furthermore, according to the present embodiment, arrows X, Y and Z indicate directions orthogonal to each other. Arrow X indicates a direction of arrangement in which the pair of vehicle system male connectors 3A and 3B is arranged and which is referred to as a “right-left direction”. Arrow Y indicates a direction in which the vehicle system male connectors 3 and the respective steering system male connectors 5 are arranged and which is referred to as a “forward-rearward direction”. Arrow Z indicates a mating direction in which the vehicle system male connectors 3 are mated with the vehicle system female connectors 4 and which is referred to as an “upward-downward direction”. One side with the vehicle system male connectors 3 along the forward-rearward direction Y on which the respective steering system male connectors 5 are located may be referred to as a “forward direction Y1” while an opposite side along the forward-rearward direction Y may be referred to as a “rearward direction Y2”.

As shown in FIGS. 2 and 3, the base 2 includes part of a plane which includes the forward-rearward direction Y and the right-left direction X. The pair of vehicle system male connectors 3A and 3B and the pair of steering system male connectors 5A and 5B stand from the base 2. The pair of vehicle system male connectors 3A and 3B is arranged along the right-left direction X. The pair of steering system male connectors 5A and 5B is arranged along the right-left direction X. The pair of vehicle system male connectors 3A and 3B and the pair of steering system male connectors 5A and 5B are arranged along the forward-rearward direction Y. The base 2, the pair of vehicle system male connectors 3A and 3B and the steering system male connectors 5A and 5B as shown in FIG. 2 form a “male connector body 20”.

Each of the pair of vehicle system male connectors 3A and 3B as shown in FIG. 4 is configured as a hybrid connector which includes a quadrilateral-tubular vehicle system male housing 30 (first housing), a power connector section 7M and a communication connector section 8M which are integrated with each other, the power connector section 7M being configured to be connected to a vehicle power supply and ground, wherein the communication connector section 8M is configured to be connected to a vehicle communication network. The power connector section 7M and the communication connector section 8M are placed within the vehicle system male housing 30 in areas partitioned by a partition wall 32, which will be described below.

The pair of vehicle system male connectors 3A and 3B is configured such that the power connector sections 7M (except for separation walls 33 including male mismating limiting sections 332 as described below) and the communication connector sections 8M are arranged symmetrically with respect to an imaginary line P (shown in FIG. 4), wherein the imaginary line P extends through a center of the base 2 along the forward-rearward direction Y.

As shown in FIG. 4, each of the vehicle system male housings 30 includes a quadrilateral-tubular vehicle system male housing main body 31, a partition wall 32, a separation wall 33, a pair of bosses 34, 34, and a limitation releasing section 35. The vehicle system male housing main body 31 stands from the base 2 in an upward direction Z1. The partition wall 32 partitions the inside of the vehicle system male housing main body 31 in the right-left direction X. The separation wall 33 partitions the inside of the power connector section 7M in the upward-downward direction Z and insulates a pair of connected portions 7A, 7A as described below. The pair of bosses 34, 34 protrudes from an outer surface of the vehicle system male housing main body 31. The limitation releasing section 35 is configured to release limitation of rotation of a lever 10 as described below.

As shown in FIG. 4, the separation wall 33 includes a separation wall main body 331 and a male mismating limiting section 332, the separation wall main body 331 extending along the right-left direction X, wherein the male mismating limiting section 332 is provided at the separation wall main body 331. One end of the separation wall main body 331 is continuous with the partition wall 32, wherein an opposite end of the separation wall main body 331 is continuous with an inner surface of the vehicle system male housing main body 31.

The male mismating limiting sections 332 of the pair of vehicle system male connectors 3A and 3B are configured with different shapes to avoid connection to an incorrect system(s). Hereinafter, the male mismating limiting section 332 in the first vehicle system male connector 3A may be referred to as a “male first mismating limiting section 332A (one mating limiting section)”, and the male mismating limiting section 332 in the second vehicle system male connector 3B may be referred to as a “male second mismating limiting section 332B (another mating limiting section)”.

As shown in FIG. 4, the male first mismating limiting section 332A is configured with a pair of first recesses 333A, 333A. The pair of first recesses 333A, 333A is provided on a face of the separation wall main body 331 oriented in the rearward direction Y2 and spaced from each other.

As shown in FIG. 4, the male second mismating limiting section 332B is configured with a pair of second recesses 333B, 333B. The pair of second recesses 333B, 333B is provided on a face of the separation wall main body 331 oriented in the forward direction Y1 and spaced from each other.

As shown in FIG. 2, the pair of bosses 34, 34 is convex from the outer surface of the vehicle system male housing main body 31 and arranged facing away from each other in the forward-rearward direction Y. Each of the bosses 34 protrudes in a cylindrical shape from the outer surface of the vehicle system male housing main body 31 to be capable of entering a boss receiving portion 414 of the vehicle system female connector 4 and a boss groove 110 of the lever 10 as described below. It is to be noted that according to the present embodiment, a distance B from a tip of each of the bosses 34 to a corresponding one of the steering system male connectors 5 in the forward-rearward direction Y should be selected to be larger than three times an axial dimension A of each of the bosses 34 (B≥A×3), as shown in FIG. 4. In the case of injection molding the vehicle system male housings 30, the distance B is ensured to be (B≥A×3) to unmold them in the forward-rearward direction Y while ensuring a strength of a mold.

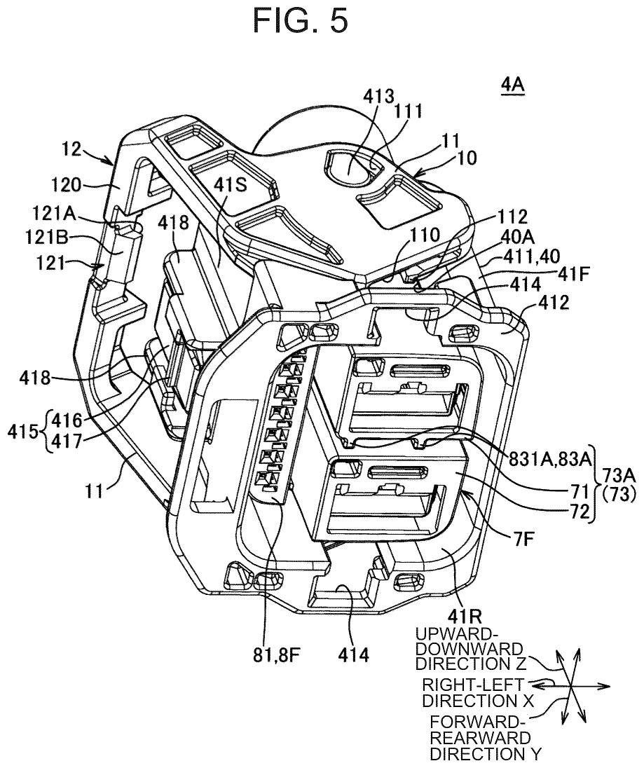

As shown in FIG. 2, the limitation releasing section 35 is placed diagonally above each of the bosses 34 and includes a slope surface, wherein ab amount of protrusion of the slope surface is increased in the downward direction Z2. This limitation releasing section 35 is configured to be introduced between a rotation limiting element 112 on the lever 10 as described below and a one side receiving portion 40A at the vehicle system female housing 40 to unlock the rotation limiting element 112 from the one side receiving portion 40A (shown in FIG. 5). The unlocking operation of the rotation limiting element 112 from the one side receiving portion 40A by the limitation releasing section 35 results in a rotatable state of the lever 10 relative to the vehicle system female housing 40.

As shown in FIG. 4, the power connector section 7M is configured with a pair of connected portions 7A, 7A. One of the pair of connected portions 7A, 7A is configured to hold a power terminal 70 to be connected to the vehicle power supply, wherein another of the pair of connected portions 7A, 7A is configured to hold a power terminal 70 to be connected to the ground. The pair of connected portions 7A, 7A is separated by the separation wall 33. The communication connector section 8M is configured to hold a signal terminal 80 to be connected to the vehicle communication network.

The vehicle system female connectors 4A, 4B (4) as shown in each of FIGS. 1 and 5 includes a pair of partner terminals (not shown), a pair of partner mated portions 71 and 72 (shown in FIG. 5), a partner signal terminal (not shown), a signal terminal holding section 81 (shown in FIG. 2), a vehicle system female housing 40 (lever housing), and a lever 10, the pair of partner terminals being configured to be connected to the pair of power terminals 70, 70 of the power connector section 7M and the pair of partner mated portions 71 and 72 holding the pair of partner connectors, wherein the partner signal terminal is configured to be connected to the signal terminal 80 of the communication connector section 8M, and the signal terminal holding section 81 holds the partner signal terminal. The vehicle system female housing 40 is configured with the pair of partner mated portions 71 and 72 and with the signal terminal holding section 81. The lever 10 is rotatably supported by the vehicle system female housing 40. The terminal holders 73 in the vehicle system female housings 40 of the pair of vehicle system female connectors 4A and 4B are configured differently from each other.

The pair of partner terminals and the pair of partner mated portions 71 and 72 form a “partner power connector section 7F” configured to be mated with the power connector section 7M, wherein the partner signal terminal and the signal terminal holding section 81 form a “partner communication connector section 8F” configured to mated with the communication connector section 8M.

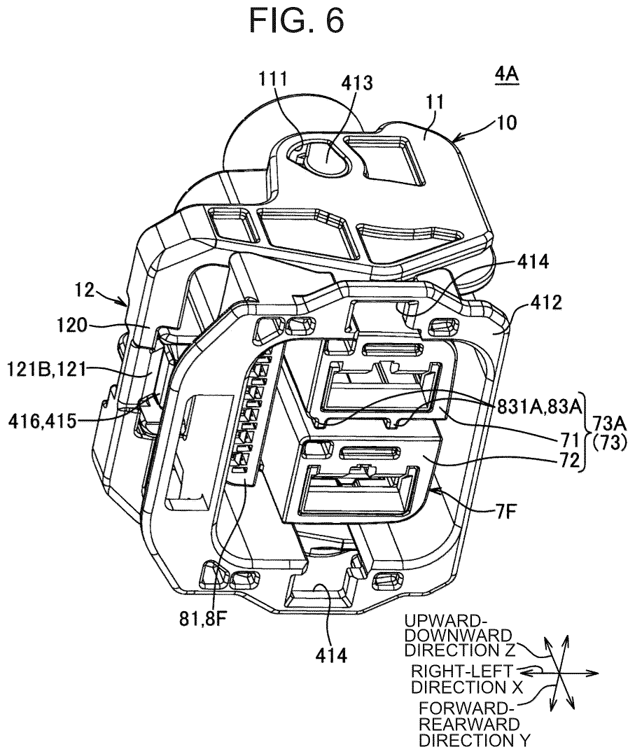

As shown in FIGS. 5 and 6, the vehicle system female housing 40 includes a vehicle system female housing main body 41, the terminal holder 73 and the signal terminal holding section 81, wherein the terminal holders 73 is supported in an engageable and disengageable manner inside the vehicle system female housing main body 41. The signal terminal holding section 81 is integrated with the vehicle system female housing main body 41. Hereinafter, as the terminal holders 73, the terminal holder 73 which is part of the first vehicle system female connector 4A may be referred to as a “first terminal holder 73A (front holder)”, and the terminal holder 73 which is part of the second vehicle system female connector 4B may be referred to as a “second terminal holder 73B (front holder)”.

As shown in FIG. 5, the vehicle system female housing main body 41 includes a tubular portion 411 having a quadrilateral tubular shape, a flange 412, a shaft portion 413, boss receiving portions 414, and a vehicle system lock arm 415 (lock portion) capable of locking the lever lock 121 provided on the lever 10 described later, the tubular portion 411 including a front wall 41F, a rear wall 41R and right and left wall portions 41S, 41S, wherein the flange 412 extends outwardly from an end edge of the tubular portion 411 facing the vehicle system male housing 30 in the mating direction Z, and the shaft portion 413 supports the lever 10 pivotably. Each of the boss receiving portions 414 is configured to receive one of the pair of bosses 34, 34 at the vehicle system male housing 30. The vehicle system lock arm 415 is configured to lock a lever lock 121 at the lever 10 which will be described below.

Each of the boss receiving portions 414 is formed by forming recesses in the flange 412 and the front and rear walls 41F and 41R of the tubular portion 411. Furthermore, each of the boss receiving portions 414 extends away from the flange 412 in the mating direction Z.

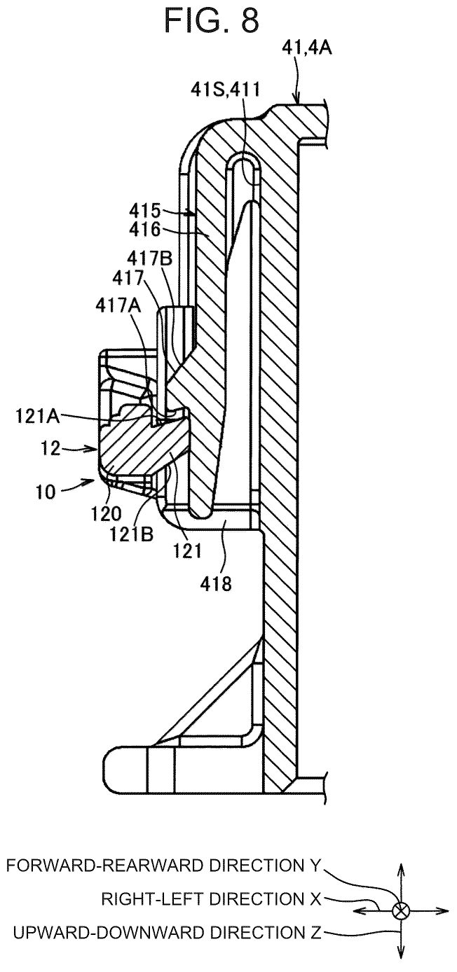

As shown in FIGS. 5 and 8, the vehicle system lock arm 415 includes a base end which is continuous with the wall portion 41S of the tubular portion 411. The vehicle system lock arm 415 includes an arm main body 416 and a connector protrusion 417, the arm main body 416 extending toward the flange 412 in the mating direction Z, wherein the connector protrusion 417 is provided on a side of the arm main body 416 facing its free end and protrudes away from the wall portion 41S in the right-left direction X.

As shown in FIG. 8, the connector protrusion 417 includes a connector contact surface 417A and a connector sliding surface 417B, the connector contact surface 417A being capable of coming into contact with a lever contact surface 121A of the lever lock 121 at the lever 10 as described below, wherein the connector sliding surface 417B is provided on a free end side of the connector contact surface 417A to be slidable on a lever sliding surface 121B of the lever lock 121.

Furthermore, a pair of opposed walls 418, 418 is provided on opposite sides of the vehicle system lock arm 415 in the forward-rearward direction Y. The pair of opposed walls 418, 418 protrudes from the wall portions 41S of the tubular portion 411 and is opposed to each other with the vehicle system lock arm 415 interposed therebetween in the forward-rearward direction Y.

As shown in FIGS. 5 and 6, the first terminal holder 73A includes a pair of partner mated portions 71 and 72 and a female first mismating limiting section 83A (partner one mating limiting section) which are integrally provided, wherein the female first mismating limiting section 83A is provided between the pair of partner mated portions 71 and 72. The female first mismating limiting section 83A includes a pair of first elevated portions 831A, 831A, wherein the pair of first elevated portions 831A, 831A protrudes from one of the pair of partner mated portions 71 and 72 toward the other of the pair of partner mated portions 71 and 72. The pair of first elevated portions 831A, 831A is engageable with the pair of first recesses 333A, 333A in the male first mismating limiting section 332A.

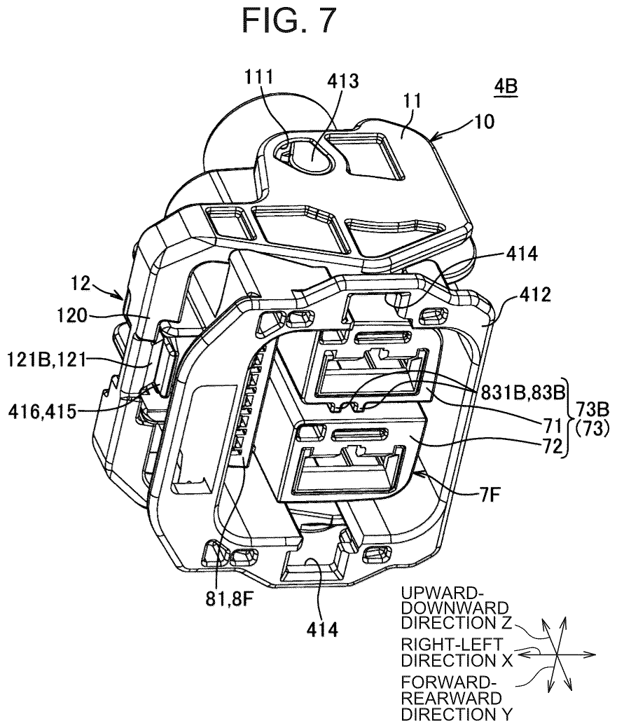

As shown in FIG. 7, the second terminal holder 73B includes a pair of partner mated portions 71 and 72 and a female second mismating limiting section 83B (partner another mating limiting section) which are integrally provided, wherein the female second mismating limiting section 83B is provided between the pair of partner mated portions 71 and 72. The female second mismating limiting section 83B includes a pair of second elevated portions 831B, 831B, wherein the pair of second elevated portions 831B, 831B protrudes from one of the pair of partner mated portions 71 and 72 toward the other of the pair of partner mated portions 71 and 72. The pair of second elevated portions 831B, 831B is engageable with the pair of second recesses 333B, 333B in the male second mismating limiting section 332B.

As shown in FIGS. 5 and 6, the lever 10 is configured to be displaced between an initial position (shown in FIG. 5) and a completely rotated position (shown in FIG. 6) by being rotated while being pivotably supported by the vehicle system female housing 40. Furthermore, the lever 10 is configured to be rotated from the initial position to reach the completely rotated position so that the vehicle system male housing 30 and the vehicle system female housing 40 are drawn toward each other and thus mated with each other.

Furthermore, while the first vehicle system male connector 3A and the first vehicle system female connector 4A are mated with each other, the vehicle system lock arm 415 in the first vehicle system female connector 4A according to the present embodiment is positioned away from the second vehicle system male connector 3B in the right-left direction X, as shown in FIG. 1. Similarly, the vehicle system lock arm 415 in the second vehicle system female connector 4B is positioned away from the first vehicle system male connector 3A in the right-left direction X.

As shown in FIGS. 5 and 6, the lever 10 is e.g. made from resin and includes a pair of arm plates 11, 11 and a coupling section 12 to be formed in a U-shape, wherein the pair of arm plates 11, 11 is coupled to each other by the coupling section 12.

The pair of arm plates 11, 11 extends in a plane spanned in the upward-downward direction Z and the right-left direction X, wherein the vehicle system female housing 40 is interposed between the pair of arm plates 11, 11 in the forward-rearward direction Y. Each of the arm plates 11 includes the boss groove 110, a shaft hole 111 and the rotation limiting element 112, the boss groove 110 being configured for engaging the boss 34 therewith and thus guiding the boss 34, wherein the shaft hole 111 is configured for inserting the shaft portion 413 of the vehicle system female housing 40 therein. When the lever 10 is in the initial position, the rotation limiting element 112 is configured to limit rotation of the lever 10 relative to the vehicle system female housing 40.

The boss groove 110 is formed in a concave groove shape in an inner surface of each of the arm plates 11. When the lever 10 is in the initial position, an open end of the boss groove 110 is positioned in a position aligned with an entrance of the boss receiving portion 414 in the vehicle system female connector 4 in the mating direction Z.

As shown in FIG. 5, the rotation limiting element 112 is provided on the inner surface of each of the arm plates 11 to protrude from an end edge of the boss groove 110 toward the vehicle system female housing 40. The rotation limiting element 112 is configured to be lockable to the one side receiving portion 40A which is provided in a step shape in the vehicle system female housing 40. When the lever 10 is in the initial position, the rotation limiting element 112 is locked to the step-shaped one side receiving portion 40A provided in the vehicle system female housing 40. In this manner, the connector structure 1 is configured to limit the rotation of the lever 10 relative to the vehicle system female housing 40. Furthermore, the rotation limiting element 112 is configured to be unlocked from the step-shaped one side receiving portion 40A in the vehicle system female housing 40 by the limitation releasing section 35 of the vehicle system male housing 30 being introduced between the rotation limiting element 112 and the one side receiving portion 40A.

As shown in FIG. 5, the coupling section 12 includes a plate-shaped coupling section main body 120 and the lever lock 121, the coupling section main body 120 coupling the pair of arm plates 11, 11, wherein the lever lock 121 protrudes from the coupling section main body 120 toward the vehicle system female housing 40 and is engageable with the vehicle system lock arm 415 of the vehicle system female housing 40.

As shown in FIG. 5, the lever lock 121 includes the connector contact surface 417A and the lever sliding surface 121B, the lever contact surface 121A being capable of coming into contact with the connector contact surface 417A, wherein the lever sliding surface 121B is facing away from the lever contact surface 121A and slidable on the connector sliding surface 417B.

For attaching such a lever 10 to the vehicle system female housing 40, the vehicle system female housing 40 is interposed between the pair of arm plates 11, 11. The shaft portion 413 is inserted into the shaft hole 111. Thus, the lever 10 is pivotably supported by the vehicle system female housing 40 to be rotated around the shaft portion 413. In addition, the one side receiving portion 40A of the vehicle system female housing 40 is locked by the rotation limiting element 112 of the lever 10. In this manner, the rotation of the lever 10 is limited and the lever 10 is positioned in the initial position. The lever 10 is thus completely attached to the vehicle system female housing 40.

Next, a mating procedure for mating the vehicle system male connectors 3 with the vehicle system female connectors 4 will be described with reference to FIG. 8.

With the levers 10 of the vehicle system female connectors 4 being positioned in the initial position, the entrances of the boss receiving portions 414 in the vehicle system female connectors 4 are moved toward the respective bosses 34 in the vehicle system male connectors 3. Each of the bosses 34 is passed through a corresponding one of entrances of the vehicle system female housings 40 to enter a corresponding boss receiving portion 414. As each of the bosses 34 is further moved to begin to enter a corresponding boss groove 110 in the lever 10, the rotation limiting element 112 is unlocked from the one side receiving portion 40A by the limitation releasing section 35 in the vehicle system male connector 3 so that the lever 10 is rotatable.

Subsequently, the levers 10 are rotated. As the levers 10 are further rotated, each of the lever locks 121 of the levers 10 is moved toward a corresponding one of the connector protrusions 417 of the vehicle system lock arms 415 in the vehicle system female housings 40. As the levers 10 are further rotated, each of the lever sliding surfaces 121B of the lever locks 121 comes into contact with a corresponding one of the the connector sliding surfaces 417B of the connector protrusions 417. As the levers 10 are further rotated, each of the lever sliding surfaces 121B slides on a corresponding one of the connector sliding surfaces 417B, wherein the arm main body 416 of the vehicle system lock arm 415 is pressed by the lever lock 121 and thus bent so that the lever lock 121 climbs up the connector protrusion 417. As the levers 10 are further rotated, each of the lever locks 121 crosses across the connector protrusion 417 so that the arm main body 416 is brought into a natural state. At this time, the lever contact surfaces 121A of the lever locks 121 and the respective connector contact surfaces 417A of the connector protrusions 417 are opposed to each other in positions which allow them to come into contact with each other so that the lever locks 121 are engaged with the respective vehicle system lock arms 415, as shown in FIG. 8. The levers 10 thus reach their completely rotated positions.

On the other hand, as the levers 10 are rotated, the vehicle system female housings 40 are drawn toward the respective vehicle system male housings 30, wherein the housings 40 and 30 are mated with each other when the levers 10 reach their completely rotated positions. At this time, the power connector sections 7M of the vehicle system male connectors 3 are mated with the respective partner power connector sections 7F of the vehicle system female connectors 4, wherein the communication connector sections 8M of the vehicle system male connectors 3 are mated with the respective partner communication connector sections 8F of the vehicle system female connectors 4. The vehicle system male connectors 3 and the vehicle system female connectors 4 are thus in a mated state. At this time, rotation of levers 10 from the completely rotated positions to their initial positions is limited through engagement of the lever locks 121 with vehicle system lock arms 415 so that the mated state of the vehicle system male connectors 3 and vehicle system female connectors 4 is maintained.

Here, for mating the first vehicle system male connectors 3A with the first vehicle system female connectors 4A, the male first mismating limiting sections 332A of the first vehicle system male connectors 3A are engaged with the respective female first mismating limiting sections 83A of the first vehicle system female connectors 4A so that the first vehicle system male connectors 3A and the first vehicle system female connectors 4A are allowed to be mated with each other. However, if the second vehicle system female connector 4B is moved toward the first vehicle system male connector 3A, the male first mismating limiting section 332A of the first vehicle system male connector 3A comes into contact with the female second mismating limiting section 83B of the second vehicle system female connector 4B so that mating the first vehicle system male connector 3A with the second vehicle system female connector 4B is limited. In this manner, mating the first vehicle system male connectors 3A with the second vehicle system female connectors 4B is limited so that connection to a different system (circuit) is limited.

Likewise, for mating the second vehicle system male connectors 3B with the second vehicle system female connectors 4B, the male second mismating limiting sections 332B of the second vehicle system male connectors 3B are engaged with the respective female second mismating limiting sections 83B of the second vehicle system female connectors 4B so that the second vehicle system male connectors 3B and the second vehicle system female connectors 4B are allowed to be mated with each other. However, if the first vehicle system female connector 4A is moved toward the second vehicle system male connector 3B, the male second mismating limiting section 332B of the second vehicle system male connector 3B comes into contact with the female first mismating limiting section 83A of the first vehicle system female connector 4A so that mating the second vehicle system male connector 3B with the first vehicle system female connector 4A is limited. In this manner, mating the second vehicle system male connectors 3B with the first vehicle system female connectors 4A is limited so that connection to a different system (circuit) is limited.

The vehicle system male connectors 3 are thus completely mated with the vehicle system female connectors 4.

As shown in FIGS. 1 and 2, the pair of steering system male connectors 5A and 5B (5) is provided on the base 2, wherein the pair of steering system male connectors 5A and 5B is arranged in the right-left direction X. Furthermore, each of the steering system male connectors 5 is mated with a corresponding one of the steering system female connectors 6A and 6B (6) so that each of the steering system male connectors 5 is in communication with a torque sensor which is an internal sensor of the electric power steering system.

As shown in FIG. 2, each of the steering system male connectors 5 includes a quadrilateral-tubular steering system male housing 50 and a male terminal section which is not shown, the steering system male housing 50 extending in the upward direction Z1 from the base 2, wherein the male terminal section is held inside the steering system male housing 50 and communicates signals from the torque sensor.

As shown in FIGS. 2 and 3, each of the steering system male housings 50 includes a quadrilateral-tubular steering system male housing main body 51 (second housing), a pair of ridges 52, 52, a steering system locked protrusion 53 (locked portion), and an instability suppressing protrusion 54, the pair of ridges 52, 52 overhanging from the steering system male housing main body 51 in the right-left direction X and extending in the upward-downward direction Z, wherein the steering system locked protrusion 53 protrudes in the forward direction Y1 from the steering system male housing main body 51.

As shown in FIG. 4, the steering system male housing main body 51 includes a front wall 51F, a rear wall 51R and a pair of right and left wall portions 51S, 51S and is formed in a quadrilateral-tubular shape, the front wall 51F and rear wall 51R being opposed to each other in the forward-rearward direction Y, wherein the pair of wall portions 51S, 51S is opposed to each other in the right-left direction X.

As shown in FIG. 3, the steering system locked protrusion 53 and the instability suppressing protrusion 54 are arranged on the front wall 51F of the steering system male housing main body 51. This means that the steering system locked protrusion 53 is facing away from the vehicle system male connector 3 in the forward-rearward direction Y.

The steering system locked protrusion 53 and the instability suppressing protrusion 54 are further arranged in the upward-downward direction Z in a center portion of the front wall 51F in the right-left direction X as shown in FIG. 3, wherein the steering system locked protrusion 53 is positioned above the instability suppressing protrusion 54 in the upward direction Z1. In addition, a gap is provided between the steering system locked protrusion 53 and the instability suppressing protrusion 54 in the upward-downward direction Z so that a steering system lock protrusion 631 of a steering system lock arm 63 is allowed to enter the gap, wherein the steering system lock arm 63 is provided at the steering system female connector 6 and will be described below.

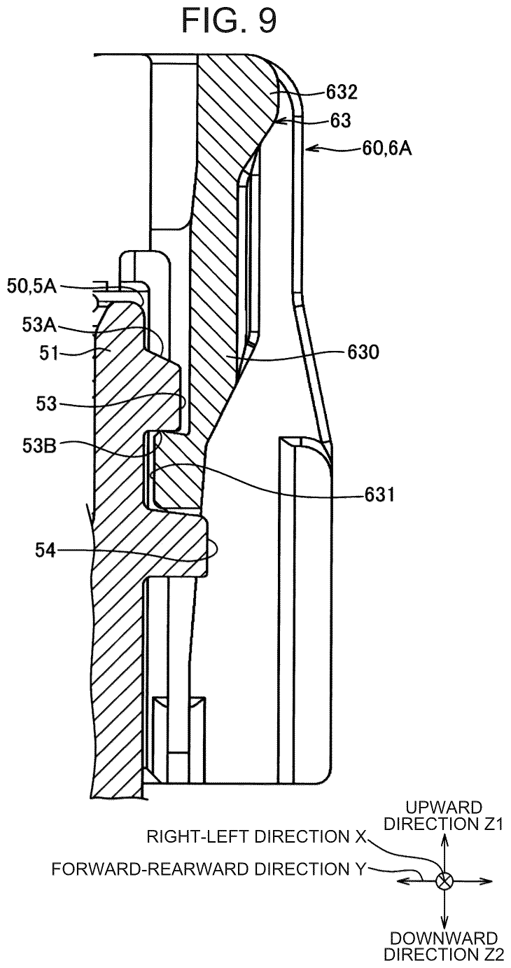

Moreover, a protrusion sliding surface 53A is provided on a face of the steering system locked protrusion 53 which is located away from the instability suppressing protrusion 54 in the upward-downward direction Z as shown in FIG. 9, wherein the protrusion sliding surface 53A is configured so that the steering system lock protrusion 631 slides on the protrusion sliding surface 53A. A protrusion contact surface 53B is provided on a face of the steering system locked protrusion 53 which is facing the instability suppressing protrusion 54, wherein the protrusion contact surface 53B is capable of coming into contact with the steering system lock protrusion 631.

As shown in FIG. 1, each of the steering system female connectors 6A and 6B (6) includes a steering system female housing 60 and a female terminal section which is not shown, the steering system female housing 60 being mateable with the steering system male housing 50, wherein the female terminal section is held inside steering system female housing 60 and configured to be connected to the male terminal section of the steering system male connector 5.

As shown in FIG. 1, the steering system female housing 60 includes a terminal holding section 61, a hood section 62, and the steering system lock arm 63 which are integrally provided, the terminal holding section 61 being configured to hold the female terminal section, wherein the hood section 62 is formed in a tubular shape surrounding the terminal holding section 61 to receive the steering system male housing 50 of the steering system male connector 5 in the hood section 62. The steering system lock arm 63 is provided at the hood section 62 and engageable with the steering system locked protrusion 53 of the steering system male connector 5.

As shown in FIG. 9, the steering system lock arm 63 includes a pair of steering system lock arm main bodies 630, 630 (only one is shown in FIG. 9), a steering system lock protrusion 631, and an operating section 632, the pair of steering system lock arm main bodies 630, 630 being continuous with an outer surface of the terminal holding section 61 and extending in the mating direction Z, wherein the steering system lock protrusion 631 couples the pair of steering system lock arm main bodies 630, 630 and protrudes toward the steering system locked protrusion 53 to be engageable with the steering system locked protrusion 53 of the steering system male connector 5. The operating section 632 is provided at free ends of the pair of steering system lock arm main bodies 630, 630. The steering system lock arm 63 and the steering system locked protrusion 53 of the steering system male connector 5 are configured to be disengaged from each other by pressing the operating section 632 down and thus bending the steering system lock arm main bodies 630, 630.

The above-described steering system lock arm 63 is configured such that mating the steering system male housing 50 with the steering system female housing 60 results in engagement of the steering system lock protrusion 631 of the steering system lock arm 63 with the steering system locked protrusion 53 of the steering system male housing 50, as shown in FIG. 9. In this manner, the connector structure 1 is configured such that a mated state of the steering system male housing 50 with the steering system female housing 60 is maintained.

In the engaged state of the steering system lock protrusion 631 of the steering system lock arm 63 with the steering system locked protrusion 53, the steering system lock protrusion 631 is positioned between the steering system locked protrusion 53 and the instability suppressing protrusion 54, as shown in FIG. 9. This may allow a possible instable assembled state of steering system female housing 60 to be suppressed.

Next, a mating procedure for mating the steering system male connectors 5 with the steering system female connectors 6 will be described with reference to FIG. 9.

First, the steering system female housings 60 are moved toward to the respective steering system male housings 50 and inserted into them. As the insertion is continued, each of the steering system lock protrusions 631 of the steering system lock arms 63 in the steering system female housings 60 comes into contact with a corresponding one of the steering system locked protrusions 53 of the steering system male housings 50. As the insertion is continued, each of the steering system lock protrusions 631 slides on the protrusion sliding surface 53A of the corresponding steering system locked protrusion 53, wherein the steering system lock arm main body 630 is bent so that the steering system lock protrusion 631 climbs and crosses across the steering system locked protrusion 53 and the steering system lock arm main body 630 is thus in a natural state. The steering system lock protrusion 631 is then positioned between the steering system locked protrusion 53 and the instability suppressing protrusion 54 and in contact with the protrusion contact surface 53B of the steering system locked protrusion 53, as shown in FIG. 9. In this manner, the steering system lock arm 63 is engaged with the steering system locked protrusion 53. Substantially at the same time, the steering system male housings 50 are mated with the respective steering system female housings 60. The steering system male connectors 5 are thus completely mated with the steering system female connectors 6.

Next, a procedure for assembling the connector structure 1 will be described. First, the steering system male connector 5A (5B) is mated with the steering system female connector 6A (6B) by a steering manufacturer. They are subsequently transferred to an automobile manufacturer from the steering manufacturer, wherein the vehicle system male connector 3A (3B) is then mated with the vehicle system female connector 4A (4B) by the automobile manufacturer. In this manner, the connector structure 1 is completely assembled.

According to the above-described embodiment, the connector structure 1 includes the base 2, the pair of vehicle system male connectors 3A and 3B (pair of first connectors) standing from the base 2, and the vehicle system female connectors 4A and 4B (lever connectors), wherein each of the vehicle system female connectors 4A and 4B is configured to be mated with one of the pair of vehicle system male connectors 3A and 3B, wherein each of the pair of vehicle system male connectors 3A and 3B includes the vehicle system male housing 30 (first housing) having a tubular shape and standing from the base 2, and the pair of bosses 34, 34 protruding from the outer surface of the vehicle system male housing 30, wherein the pair of bosses 34, 34 is facing away from each other in the orthogonal direction (forward-rearward direction Y) extending orthogonally to the direction of arrangement (right-left direction X) in which the pair of vehicle system male connectors 3A and 3B is arranged.

If the pair of bosses were arranged in the direction of arrangement of the pair of vehicle system male connectors 3A and 3B as conventional, the pair of vehicle system male connectors 3A and 3B should be spaced from each other by a predetermined dimension including a dimension for demolding. However, the pair of bosses 34, 34 according to the present embodiment is facing away from each other in the orthogonal direction extending orthogonally to the direction of arrangement in which the pair of vehicle system male connectors 3A and 3B is arranged, which enables the pair of vehicle system male connectors 3A and 3B to be moved toward each other. This may allow miniaturization in the direction of arrangement (right-left direction X) of the pair of vehicle system male connectors 3A and 3B.

The connector structure 1 further includes a pair of vehicle system female connectors 4A and 4B (lever connectors), wherein the lever 10 of one of the pair of vehicle system female connectors 4A and 4B has a direction of rotation R1 opposite to a direction of rotation R2 of the lever 10 of another of the pair of vehicle system female connectors 4A and 4B. This means that the lever 10 of the first vehicle system female connector 4A and the lever 10 of the second vehicle system female connector 4B are rotated to be tilted in different directions R1, R2 along the right-left direction X. If the pair of levers 10, 10 were rotated in the same direction, there would be the risk of disengagement of the levers 10, 10 from the respective vehicle system female housings 40 of the pair of vehicle system female connectors 4A and 4B upon application of load to the male connector body 20. However, the pair of levers 10, 10 according to the present embodiment is rotated in different directions R1, R2 so that the risk of disengagement is reduced, which may ensure redundancy.

The connector structure 1 further includes a pair of vehicle system female connectors 4A and 4B (lever connectors), wherein each of the vehicle system female connectors 4A and 4B includes the vehicle system lock arm 415 (lock portion) configured to lock the lever 10 when the vehicle system male housing 30 (first housing) and the vehicle system female housing 40 (lever housing) are mated with each other, and wherein one of the pair of vehicle system female connectors 4A and 4B is interposed between the vehicle system lock arm 415 and another of the pair of vehicle system female connectors 4A and 4B and the vehicle system lock arm 415 is facing away from the another of the pair of vehicle system female connectors 4A and 4B with respect to the one of the pair of vehicle system female connectors 4A and 4B. This may allow further miniaturization in the direction of arrangement (right-left direction X) of the pair of vehicle system male connectors 3A and 3B.

Furthermore, the first vehicle system male connector 3A includes the male first mismating limiting section 332A (one mating limiting section) inside the vehicle system male housing 30, wherein the second vehicle system male connector 3B includes the male second mismating limiting section 332B (another mating limiting section) inside the vehicle system male housing 30. In this manner, the male mismating limiting sections 332 are provided inside the respective vehicle system male housings 30, which enables a structure for preventing mismating to be obtained without increase in size.

Furthermore, each of the first vehicle system female connector 4A (one lever connector) and the second vehicle system female connector 4B (another lever connector) includes the vehicle system female housing 40 (lever housing) and the terminal holder 73 (front holder) configured to be engaged with and disengaged from the vehicle system female housing 40, wherein the first vehicle system female connector 4A includes the female first mismating limiting section 83A (partner one mating limiting section) associated with the male first mismating limiting section 332A (one mating limiting section), wherein the first terminal holder 73A (first front holder) includes the female first mismating limiting section 83A, wherein the second vehicle system female connector 4B includes the female second mismating limiting section 83B (partner another mating limiting section) associated with the male second mismating limiting section 332B (another mating limiting section), and wherein the second terminal holder 73B (second front holder) includes the female second mismating limiting section 83B. This enables a configuration which allows the terminal holders 73A and 73B to be replaced in the vehicle system female housings 40. For example, when types of vehicle system male housing 30 are increased, it is thus only necessary to produce one or more terminal holders 73A, 73B without modifying the geometry of the vehicle system female housings 40 in order to obtain a structure for preventing mismating.

The connector structure 1 further includes the steering system male connectors 5 (second connectors) standing from the base 2; and the steering system female connectors 6 (partner connectors) configured to be mated with the respective steering system male connectors 5, wherein each of the steering system male connectors 5 includes the steering system male housing main body 51 (second housing) having a tubular shape and standing from the base 2, and the steering system locked protrusion 53 (locked portion) protruding from the outer surface of the steering system male housing main body 51 and configured for maintaining the mated state with the steering system female connector 6, and wherein the steering system locked protrusion 53 is provided at the location of the steering system male housing main body 51 which is facing away from the vehicle system male connector 3 in the orthogonal direction (forward-rearward direction Y). This enables a mating operation of the steering system male connectors 5 with the steering system female connectors 6 to be carried out with a good workability while ensuring a work space.

Moreover, for assembling the connector structure 1, the steering system male connectors 5 are first mated with the steering system female connectors 6 by a steering manufacturer, and the vehicle system male connectors 3 are subsequently mated with the vehicle system female connectors 4 by an automobile manufacturer. In this manner, the mating operation of the vehicle system male connectors 3 with the vehicle system female connectors 4 is possible without affecting the mated state of the steering system male connectors 5 with the steering system female connectors 6 which have been already mated.

It should be noted that the present invention is not limited to the above-described embodiment, but includes other embodiments or the like which may achieve the objective of the present invention, wherein the present invention includes exemplar variations as follows.

While the lever 10 of each of the first vehicle system female connectors 4A according to the above-described embodiment is configured to be rotated in the direction of rotation R1 (clockwise) to reach the completely rotated position from the initial position, the present invention is not limited thereto. The lever 10 of each of the first vehicle system female connectors 4A may be configured to be rotated counterclockwise to reach the completely rotated position from the initial position. Likewise, while the lever 10 of each of the second vehicle system female connectors 4B according to the above-described embodiment is configured to be rotated in the direction of rotation R2 (counterclockwise) to reach the completely rotated position from the initial position, the present invention is not limited thereto. The lever 10 of each of the second vehicle system female connectors 4B may be configured to be rotated clockwise to reach the completely rotated position from the initial position.

Although the best configuration, method etc. for implementing the present invention are disclosed in the above description, the present invention is not limited thereto. Namely, while the present invention is particularly shown and described mainly with regard to the specific embodiments, the above mentioned embodiments may be modified in various manners in shape, material characteristics, amount or other detailed features by those skilled in the art without departing from the scope of the technical idea and purpose of the present invention. Therefore, the description with limited shapes, material characteristics etc. according to the above disclosure is not limiting the present invention, but merely illustrative for easier understanding the present invention so that the description using names of the elements without a part or all of the limitations to their shapes, material characteristics etc. is also included in the present invention.

### REFERENCE SIGNS LIST

1 Connector structure
2 Base
3A, 3B (3) Pair of first connectors
3A First vehicle system male connector (one first connector; first connector)
3B Second vehicle system male connector (another first connector; first connector)
30 Vehicle system male housing (first housing)
332A Male first mismating limiting section (one mating limiting section)
332B Male second mismating limiting section (another mating limiting section)
34, 34 pair of bosses
4A First vehicle system female connector (one lever connector; lever connector)
4B Second vehicle system female connector (another lever connector; lever connector)
40 Vehicle system female housings (lever housings)
415 Vehicle system lock arm (lock portion)
5A First steering system male connector (second connector)
5B Second steering system male connector (second connector)
51 Steering system male housing main body (second housing)
53 Steering system locked portions (locked portions)
6A First steering system female connector (partner connector)
6B Second steering system female connector (partner connector)
73A First terminal holder (first front holder)
73B Second terminal holder (second front holder)
83A Female first mismating limiting section (partner one mating limiting section)
83B Female second mismating limiting section (partner another mating limiting section)
10 Levers
110 Boss grooves
X Right-left direction (direction of arrangement in which the pair of first connectors is arranged)
Y Forward-rearward direction (orthogonal direction)
R1, R2 Directions of rotation of the levers

What is claimed is:

1. A connector structure comprising:
a base;
a pair of first connectors standing from the base; and
a lever connector configured to be mated with the pair of first connectors,
wherein each of the pair of first connectors includes:
a first housing having a tubular shape and standing from the base; and
a pair of bosses protruding from an outer surface of the first housing,
wherein the lever connector includes:
a lever housing configured to be mated with the first housing; and
a lever including boss grooves, each of the boss grooves being configured to insert one of the pair of bosses therein,
wherein the lever is pivotably supported by the lever housing so that rotation of the lever moves the first housing and the lever housing toward each other,
wherein the pair of bosses is facing away from each other in an orthogonal direction extending orthogonally to a direction of arrangement in which the pair of first connectors is arranged.

2. The connector structure according to claim 1, comprising a pair of lever connectors including the lever connector,
wherein the lever of one of the pair of lever connectors has a direction of rotation opposite to a direction of rotation of the lever of another of the pair of lever connectors.

3. The connector structure according to claim 1, comprising a pair of lever connectors including the lever connector,
wherein the lever housing includes a lock portion configured to lock the lever when the first housing and the lever housing are mated with each other, and
wherein the lock portion is provided at a location of one of the pair of lever connectors facing away from the another of the pair of lever connectors.

4. The connector structure according to claim 1, comprising a pair of lever connectors including the lever connector,
wherein one first connector of the pair of first connectors is configured to be mated with one lever connector of the pair of lever connectors,
wherein another first connector of the pair of first connectors is configured to be mated with another lever connector of the pair of lever connectors,
wherein the one first connector includes:
a first housing; and
one mating limiting section configured to allow the one first connector to be mated with the one lever connector and to limit mating of the one first connector with the another lever connector,
wherein the one mating limiting section is placed inside the first housing,
wherein the another first connector includes:
a first housing; and
another mating limiting section configured to allow the another first connector to be mated with the another lever connector and to limit mating of the another first connector with the one lever connector,
wherein the another mating limiting section is placed inside the first housing.

5. The connector structure according to claim 4,
wherein the one lever connector includes:
a lever housing;
a first front holder configured to be engaged with and disengaged from the lever housing; and
a partner one mating limiting section configured to be engaged with the one mating limiting section,
wherein the first front holder includes the partner one mating limiting section,
wherein the another lever connector includes:
a lever housing;
a second front holder configured to be engaged with and disengaged from the lever housing; and
a partner another mating limiting section configured to be engaged with the another mating limiting section, and
wherein the second front holder includes the partner another mating limiting section.

6. The connector structure according to claim 1, comprising:
a second connector standing from the base; and
a partner connector configured to be mated with the second connector,
wherein the second connector includes:
a second housing having a tubular shape and standing from the base; and
a locked portion protruding from an outer surface of the second housing and configured to be engaged with the partner connector, and
wherein the locked portion is provided at a location of the second housing which is facing away from the first connector in the orthogonal direction.
